(19) United States
(12) Patent Application Publication
(10) Pub. No.: US 2001/0038898 A1
(43) Pub. Date: Nov. 8, 2001

(54) SECURITY PROTECTION DOUBLE PAPER FOR FACSIMILE RECEPTION

(76) Inventor: MASATO MAEDA, TOKYO (JP)

Correspondence Address: ARMSTRONG,WESTERMAN, HATTORI,, MCLELAND & NAUGHTON, LLP, 1725 K STREET, NW, SUITE 1000, WASHINGTON, DC, 20006, US

(21) Appl. No.: 09/029,761

(22) PCT Filed: Sep. 2, 1996
(86) PCT No.: PCT/JP96/02479

§ 371 Date: None

(30) Foreign Application Priority Data
Sep. 1, 1995 (JP) 7/260647
Sep. 1, 1996 (JP) 8/267649

(51) Int. Cl. B32B 7/06

(52) U.S. Cl. 428/40.1; 428/195

(57) ABSTRACT

The present invention aims to provide a contents-protectable double-layered facsimile recording paper which can prevent the contents of the communication from being read or seen through the top or back surface of the recording paper, and which can reduce the total consumption of the recording paper. The contents-protectable double-layered facsimile recording paper includes: a continuous thermal recording sheet 1, on which an address recording area 4 and a text recording area 5 are formed; a continuous coating sheet 2; and an adhesive layer 3 for bonding the coating sheet 2 onto the thermal recording sheet 1 in a peelable manner. The adhesive layer 3 does not allow the coating sheet 2 to be re-bonded after the coating sheet 2 has been peeled off once. The address recording area 4 is formed along the right (or left) edge of the continuous thermal recording sheet 1, while the text recording area 5 is formed on the left (or right) side of the address recording area 4. Fine patterns 6, 6 are printed on the top surface and/or the back surface of the coating sheet 2, and on the back surface of the thermal recording sheet 1 in order to prevent the contents of the communication from being read through the top surface of the coating sheet 2 or the back surface of the thermal recording sheet 1.

### FIELD OF THE INVENTION

This invention relates to a thermal recording paper used in facsimile machines and more particularly, to a contents-protectable double-layered recording paper used in a facsimile communication system.

### BACKGROUND OF THE INVENTION

In conventional facsimile communication services, a great deal of demand has arisen for confidentiality of communication and for a practical system that can reliably protect the contents of communications.

Several proposals have been made on facsimile recording paper.

The first proposal is made in Japanese Patent Application Laid-open No. 61-248784, which discloses a facsimile recording paper comprising a base layer, a chromogenic layer which is formed on the base layer and which is for generating colors in response to a heat application, and an opaque cover sheet which is formed on the chromogenic layer in a removable manner so as to cover at least a part of the chromogenic layer.

The second proposal is made in Japanese Patent Application Laid-open No. 61-248785, which discloses a facsimile recording paper comprising transparent a base layer, an opaque cover sheet which is formed on one surface of the base layer in a removable manner so as to cover at least a part of said surface, a chromogenic layer which is formed on the other surface of the base layer and which is for generating colors in response to a heat application, and an opaque layer which is formed on the chromogenic layer.

The third proposal is made in Japanese Patent Application Laid-open No. H2-69359, which discloses a contents-protectable thermal recording medium comprising a support layer, and a thermal recording layer which is formed on the support layer. The thermal recording layer contains a chromogenic agent, and a pigmentary agent which pigmentizes when it comes into contact with the chromogenic agent. The entire surface of the thermal recording layer is covered with an opaque cover sheet which is adhered onto the thermal recording layer in a removable manner. The opaque cover sheet has a transparent or semi-transparent area, through which the information recorded on the thermal recording layer can be read.

The cover sheet may further be covered with an over-coating layer.

The fourth proposal is made in Japanese Patent Application Laid-open No. H2-178093, which discloses a facsimile recording paper comprising a thermal recording sheet for recording the received information, and a cover sheet which is adhered onto the top surface of the thermal recording sheet in a removable manner and which is for concealing the received information recorded on the thermal recording sheet (hereinafter referred to as “first embodiment”).

This publication also discloses that the first embodiment of the facsimile recording paper may have an alignment mark provided on the facsimile recording paper.

This publication further discloses that the first embodiment of the facsimile recording paper may have an address recording area in which addressee's information is recorded so that it can be read externally (hereinafter referred to as “third embodiment”).

This publication further discloses that the third embodiment of the facsimile recording paper may have a feature that the cover sheet is a thermal recording sheet having an address recording area, and that the entire area on the thermal recording sheet, except for the address recording area, is pretreated so that it can prevent the recorded information from being read by a third person.

This publication further discloses that the third embodiment of the facsimile recording paper may have a feature that the cover sheet is a regular paper which has been subjected to a pretreatment for concealing the recorded information from being read by a third person, and that an address area is formed on the cover sheet by applying a heat sensitive agent on the cover sheet.

This publication further discloses that the third embodiment of the facsimile recording paper may have a feature that the cover sheet is a regular paper which has been subjected to a pretreatment for concealing the recorded information from being read by a third person, and that an address area is formed on the cover sheet by forming a window in the cover sheet, through which the thermal recording sheet (i.e., the underlayer) is exposed.

However, the conventional contents-protectable double-layered paper used in facsimile machines have a problem that if the thickness of the thermal recording sheet is reduced, the contents of the received information recorded in the text recording area may be seen through the top or back face of the recording paper.

The inventor of the present invention came across this drawback during the test production of double-layered facsimile recording paper.

Another problem with the conventional double-layered facsimile recording paper is that an upper portion of each page is used as an address area regardless of the amount of received data. If the communication extends over two or more pages, the address areas of the second and later pages are of no use.

Furthermore, if the communication is finished in the middle of a page (which may be the first page if the amount of received information is very small), the rest of the page is left blank and the entire page is output.

Therefore, it is the first object of the present invention to provide a double-layered facsimile recording paper which can prevent the contents of the received information recorded on the thermal recording sheet from being seen or read through the back face of the recording paper.

It is the second object of the present invention to provide an economical double-layered facsimile recording paper, eliminating wasteful paper consumption.

### SUMMARY OF THE INVENTION

The present invention contains four preferred embodiments.

In the first embodiment of the present invention, a contents-protectable double-layered facsimile recording paper comprises: a thermal recording sheet 1 having an address recording area 4 and a text recording area 5; a coating sheet 2, laid over the thermal recording sheet 1, for preventing the contents of received information recorded in the text recording area 5 from being seen by a third person; and an adhesive layer 3 for bonding the coating sheet 2 onto the top surface of the thermal recording sheet 1 in a peelable manner. This adhesive layer 3 does not allow the coating sheet 2 to be rebonded after the coating sheet 2 has once been peeled off. Fine patterns 6 are printed on the top surface and/or back surface of the coating sheet 2 in order to prevent the received information recorded on the thermal recording sheet 1 from being seen through the coating sheet 2. A fine pattern 6 is also printed on the back surface of the thermal recording sheet 1 in the area corresponding to the text recording area 5 in order to prevent the received information recorded in the text recording area 5 from being read from the back by a third person.

In the second embodiment of the present invention, the contents-protectable double-layered facsimile recording paper, described in the first embodiment, has a thermosensitive agent 9 applied onto the top surface of the coating sheet 2 in the area corresponding to the address recording area 4 of the thermal recording sheet 1.

In the third embodiment of the present invention, the contents-protectable double-layered facsimile recording paper, described in the first embodiment, has a coating sheet 2 with a transparent area 7 through which the address recording area 4 of the thermal recording sheet 1 can be seen, and a nontransparent area 8 which does not allow the text recording area 5 of the thermal recording paper 1 to be seen. A control marker 10 is provided at an appropriate position in the address recording area 4 of the thermal recording sheet 1 or at an appropriate position in the transparent area 7 of the coating sheet 2 laid over the address recording area 4.

In the fourth embodiment of the invention, a contents-protectable double-layered facsimile recording paper comprises: a continuous thermal recording sheet (1) having an address recording area (4) and a text recording area (5); a continuous coating sheet (2), laid over the thermal recording sheet (1), for preventing the contents of received information recorded in the text recording area (5) from being seen by a third person; and an adhesive layer (3) for bonding the coating sheet (2) onto the top surface of the thermal recording sheet (1) in a peelable manner. This adhesive layer does not provide a bonding function after the coating sheet (2) has been peeled off once. The address recording area (4) is continuously formed along the right (or left) edge of the continuous thermal recording sheet (1), while the text recording area (5) is continuously formed in the left (or right) side of the address recording area (4) in the longitudinal direction of the thermal recording sheet (1). Fine patterns (6) are printed on the top surface and/or back surface of the coating sheet (2) in order to prevent the received information recorded on the thermal recording sheet (1) from being seen through the coating sheet (2). A fine pattern (6) is also printed on the back surface of the thermal recording sheet (1) in the area corresponding to the text recording area (5) in order to prevent the received information recorded in the text recording area (5) from being read from the back by a third party.

### BRIEF DESCRIPTION OF THE DRAWINGS

FIG. 1 illustrates the contents-protectable double-layered facsimile recording paper according to the first embodiment of the present invention.

FIG. 2 illustrates the contents-protectable double-layered facsimile recording paper according to the second embodiment of the present invention.

FIG. 3 illustrates the contents-protectable double-layered facsimile recording paper according to the third embodiment of the present invention.

FIG. 4 illustrates the contents-protectable double-layered facsimile recording paper according to the fourth embodiment of the present invention.

### PREFERRED EMBODIMENTS OF THE INVENTION

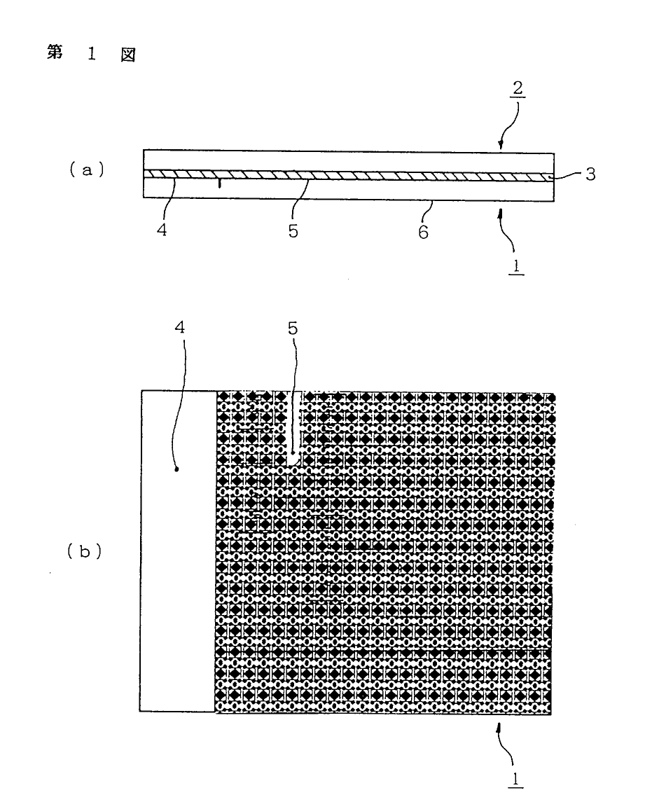

The contents-protectable double-layered facsimile recording paper according to the first embodiment will now be described with reference to FIG. 1.

FIG. 1(a) is a vertical cross-sectional view of the facsimile recording paper according to the first embodiment of the present invention.

The facsimile recording paper comprises: a thermal recording sheet 1; a coating sheet 2; and an adhesive layer 3. Fine patterns 6 are printed on the top surface (and/or the back surface) of the coating sheet 2, and on the back surface of the thermal recording sheet 1.

The thermal recording sheet 1 comprises a base sheet, on which two types of chemical compounds are applied. During the recording operation, one of the two compounds melt due to heat and then, reacts with the other compound, thereby generating a color.

The adhesive layer 3 bonds the coating sheet 2 onto the thermal recording sheet 1 in a peelable manner. If the coating sheet 2 is peeled off once, the adhesive layer 3 does not function to bond any longer, and re-bonding of the coating sheet 2 and the thermal recording sheet 1 is impossible.

FIG. 1(b) is a plan view of the thermal recording sheet 1.

As shown in FIG. 1(b), the thermal recording sheet 1 has an address recording area 4 and a text recording area 5. The address recording area 4 generally occupies the top portion of the sheet (i.e., the left end in FIG. 1(b)), in which information about the addressee are recorded. The text recording area 5 occupies the rest of the area (i.e., the right side area in FIG. 1(b)), in which the contents of the received communication is recorded.

A person who received the facsimile can peel off the coating sheet 2 from the thermal recording sheet 1, and can read the communication recorded in the text recording area 5 of the thermal recording sheet 1.

Once the coating sheet 2 is peeled off from the thermal recording sheet 1, it cannot be rebonded to the thermal recording sheet 1 to prevent a third person from reading the communication. Thus, the facsimile recording paper can protect the contents of the communication, and prevent a third person from reading the communication recorded in the text recording area 5 of the thermal recording sheet 1.

In addition, the fine pattern 6 printed on the back of the thermal recording sheet 1 can prevent the communication recorded in the text recording area 5 from being seen through the back surface of the facsimile recording paper.

For the sake of comparison, a double-layered facsimile recording paper, having a back surface (that is, the back surface of the thermal recording sheet 1) which was colored in black, was prepared. Then, the facsimile received state was observed. The test result was that the text recorded on the top surface of the thermal recording sheet 1 is likely to be read from the back surface even if the back surface was blackened.

Thus, it was found that the fine pattern 6 printed on the back surface of the thermal recording sheet 1 is more effective in concealing the contents of the communication from being seen or read by a third person, as compared with the blackened thermal recording sheet.

Next, the second embodiment of the present invention will be described.

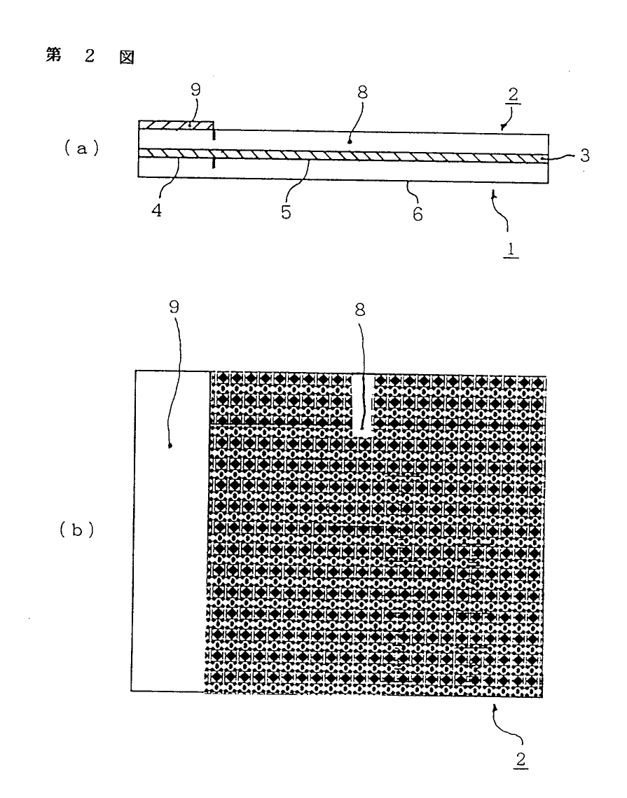

FIG. 2 illustrates the contents-protectable double-layered facsimile recording paper according to the second embodiment of the present invention. FIG. 2(a) is a cross-sectional view of the facsimile recording paper.

As shown in FIG. 2(a), the facsimile recording paper comprises a thermal recording sheet 1, a coating sheet 2, and an adhesive layer 3. A fine pattern 6 is printed on the back surface of the thermal recording sheet 1.

FIG. 2(b) is a plan view of the coating sheet 2.

The coating sheet 2 has a nontransparent area 8. The rest of the area on the coating sheet is coated with a thermosensitive agent 9.

The area on the coating sheet 2, to which the thermosensitive agent 9 is applied, corresponds to the address recording area 4 of the thermal recording paper 1.

In other words, the coating sheet 2 is made of a nontransparent sheet material, and a thermosensitive area is formed on it so as to correspond to the address recording area 4.

The other structure is the same as that in the first embodiment. (A control marker may be provided at an appropriate position on the top surface of the thermosensitive area of the coating sheet 2, which corresponds to the address recording area 4 of the thermal recording sheet 1. The particulars of the control marker will be described in the third embodiment.) The third embodiment of the present invention will be described below.

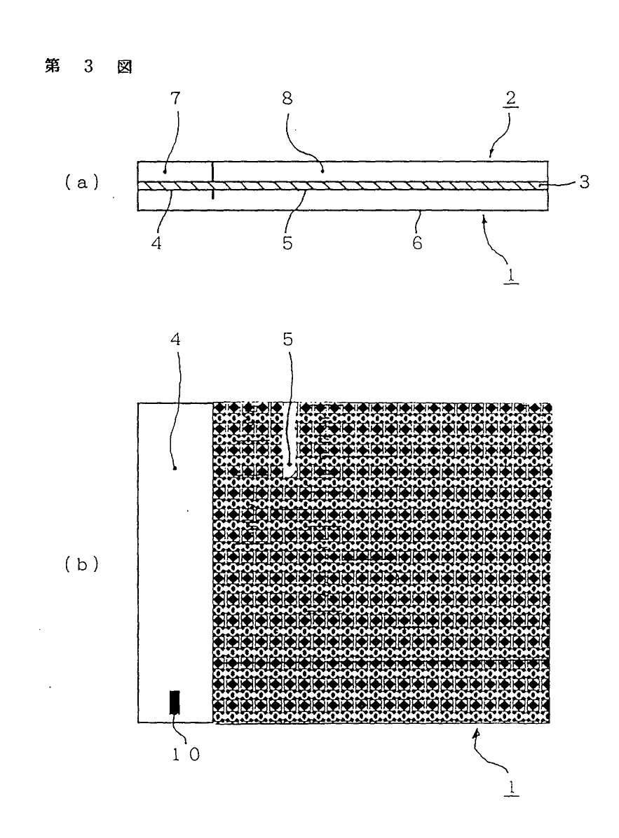

FIG. 3 illustrates the contents-protectable double-layered facsimile recording paper according to the third embodiment of the present invention. FIG. 3(a) is a cross-sectional view of the facsimile recording paper.

As shown in FIG. 3(a), the facsimile recording paper comprises a thermal recording sheet 1, a coating sheet 2, and an adhesive layer 3. A fine pattern 6 is printed on the back surface of the thermal recording sheet 1. The coating sheet 2 has a transparent area 7 and a nontransparent area 8.

In third embodiment, the coating sheet 2 is made of a transparent sheet material, and the nontransparent area 8 is formed on the coating sheet 2 by printing a fine pattern 6 on the transparent sheet material.

FIG. 3(b) is a plan view of the thermal recording sheet 1.

The thermal recording sheet 1 has an address recording area 4 and a text recording area 5. A control marker 10 is located in the address recording area 4.

The control marker 10 is marked with, for example, a black ink at an appropriate position in the address recording area 4. The position of the control marker 10 must be selected in accordance with the position of the control marker detection sensor installed in a facsimile machine.

The control marker 10 is provided in order to accurately detect the boundary between the address recording area 4 and the text recording area 5 when a continuous recording paper (e.g., a roll paper) is used.

The control marker 10 may be provided in the transparent area 7 of the coating sheet 2, which lies over the address recording area 4 of the thermal recording sheet 1.

The other structure of the third embodiment is the same as that shown for the first embodiment.

Finally, the fourth and fifth embodiments of the present invention will be described below.

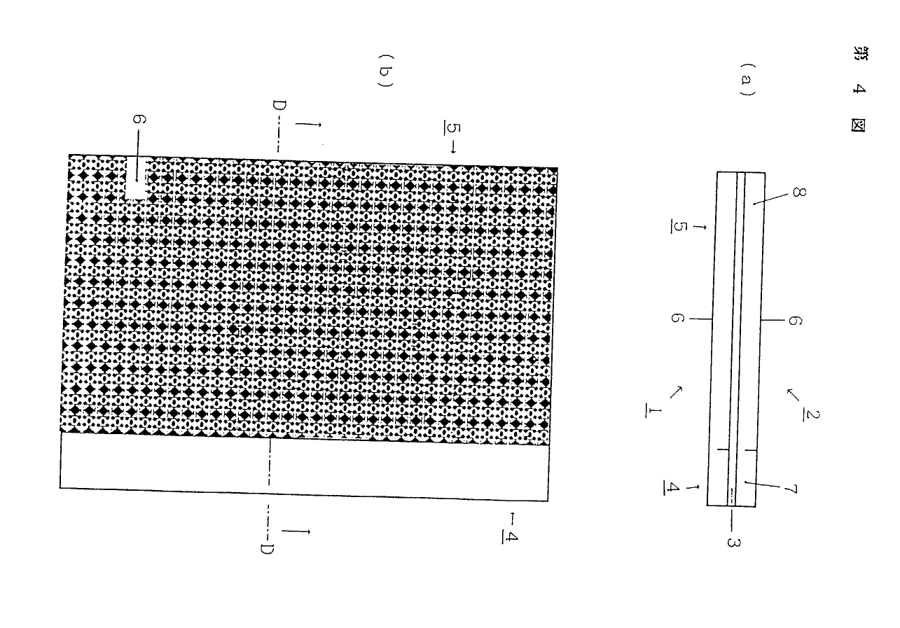

FIG. 4 illustrates the contents-protectable double-layered facsimile recording paper according to the fourth embodiment of the present invention.

As shown in FIG. 4(a), the facsimile recording paper comprises a continuous type (for example, a roll type) thermal recording sheet 1, a continuous type (for example, a roll type) coating sheet 2, and an adhesive layer 3. A fine pattern 6 is printed on the back surface of the thermal recording sheet 1.

In the fourth embodiment, as shown in FIG. 4(b), the thermal recording sheet 1 has an address recording area 4, which extends along the right edge of the thermal recording sheet 1, and a text recording area 5, which occupies the rest of the area along the longitudinal direction of the thermal recording sheet 1.

The other structure is the same as that shown for the first and second embodiment.

In the fifth embodiment, the address recording area is formed along the left edge of the thermal recording sheet, which extends in the longitudinal direction.

In the fourth and fifth embodiments of the present invention, the continuous recording paper is cut off wherever the communication data is finished.

### INDUSTRIAL UTILIZATION

In the present invention, a fine pattern is printed on the back of the double-layered facsimile recording paper (that is, on the back surface of the thermal recording sheet), which can prevent the contents of the communication, recorded on the text recording area of the thermal recording sheet, from being read or seen through the back face of the recording paper.

Fine patterns are also printed on the coating sheet in order to prevent the contents recorded on the thermal recording sheet from being seen through the top surface of the recording paper.

When using a continuous type recording paper, it can be cut off wherever the recorded data is finished, thereby reducing the total paper consumption.

Thus, a reliable and secure facsimile communication system is realized using the contents-protectable double-layered facsimile recording paper of the present invention:

What is claimed is:

1. A contents-protectable double-layered facsimile recording paper comprising:
a thermal recording sheet (1) having an address recording area (4) and a text recording area (5);
a coating sheet (2), laid over said thermal recording sheet (1), for preventing contents of information received and recorded in said text recording area (5) from being seen by a third person;
an adhesive layer (3) for bonding said coating sheet (2) onto a top surface of said thermal recording sheet (1) in a peelable manner, said adhesive layer (3) not functioning to bond said coating sheet to said thermal recording sheet any longer, after said coating sheet (2) has once been peeled off, wherein fine patterns (6) are printed on any one of a top surface, a back surface, and both said top surface and said back surface of said coating sheet (2) in order to prevent said information received and recorded on said thermal recording sheet (1) from being seen through said coating sheet (2); and
a fine pattern (6) printed on a back surface of said thermal recording sheet (1) in an area corresponding to said text recording area (5) in order to prevent said information received and recorded in said text recording area (5) from being read through said back surface of said thermal recording sheet by the third person.

2. The contents-protectable double-layered facsimile recording paper according to claim 1, wherein a thermosensitive agent (9) is applied onto said top surface of said coating sheet (2) in an area corresponding to said address recording area (4) of said thermal recording sheet (1).

3. The contents-protectable double-layered facsimile recording paper according to claim 1, wherein said coating sheet (2) has a transparent area (7) through which said address recording area (4) of said thermal recording sheet (1) can be seen, and a nontransparent area (8) which does not allow said text recording area (5) of said thermal recording paper (1) to be seen, and wherein a control marker (10) is provided at any one of an appropriate position in said address recording area (4) of said thermal recording sheet (1) and at an appropriate position in said transparent area (7) of said coating sheet (2) over said address recording area (4).

4. A contents-protectable double-layered facsimile recording paper according to claim 1, comprising:
a continuous thermal recording sheet (1) having an address recording area (4) and a text recording area (5);
a continuous coating sheet (2), laid over the thermal recording sheet (1), for preventing contents of information received and recorded in said text recording area (5) from being seen by a third person;
an adhesive layer (3) for bonding the coating sheet (2) onto a top surface of said thermal recording sheet (1) in a peelable manner, said adhesive layer not functioning to bond said coating sheet to said thermal recording sheet any longer after said coating sheet (2) has been peeled off once, wherein said address recording area (4) is continuously formed along any one of a right edge and a left edge of said continuous thermal recording sheet (1), while said text recording area (5) is continuously formed in any one of a left side or a right side of said address recording area (4) along a longitudinal direction of said thermal recording sheet (1);
fine patterns (6) printed on any one of a top surface, a back surface, and both said top and back surfaces of said coating sheet (2) in order to prevent said information received and recorded on said thermal recording sheet (1) from being seen through said coating sheet (2); and
a fine pattern (6) printed on said back surface of said thermal recording sheet (1) in an area corresponding to said text recording area (5) in order to prevent said information received and recorded in said text recording area (5) from being read through said back of said thermal recording sheet by the third person.
